(19) United States
(12) Patent Application Publication
(10) Pub. No.: US 2020/0121986 A1
(43) Pub. Date: Apr. 23, 2020

(54) ATHLETE VITAL SIGN MONITORING SYSTEM

(71) Applicant: Covidien LP, Mansfield, MA (US)

(72) Inventors: Benjamin Morris, Washington, DC (US); Jonathan James Woodward, Annapolis, MD (US); Stephen Roland Fellner, Auckland (NZ); Nicholas Alistair Close, Auckland (NZ)

(21) Appl. No.: 16/165,615

(22) Filed: Oct. 19, 2018

(51) Int. Cl. A63B 24/00; H04Q 9/00

(52) U.S. Cl. CPC A63B 24/0062; H04Q 9/00; H04Q 2209/43; A63B 2220/40; A63B 2230/06; A63B 2230/202; A63B 2230/207; A63B 2225/52

(57) ABSTRACT

Methods, systems, and devices for athlete monitoring are described. The method may include receiving, at a gateway device, physiological measurement data from a sensor configured to transmit wireless signals according to a Bluetooth 5 protocol. The method may further include identifying a user associated with the received physiological measurement data based at least in part on an identity of the sensor and storing at least the received physiological measurement data. In some cases, the method may include receiving the physiological measurement data via one or more of a plurality of repeaters that are configured to transmit wireless signals according to the Bluetooth 5 protocol.

### BACKGROUND

The following relates generally to athlete monitoring, and more specifically to an athlete vital sign monitoring system.

In a designated area, such as a healthcare facility or sports arena, physiological parameters of the user (e.g., heart rate, respiratory rate, blood pressure) may be monitored by one or more sensors. The sensors may be battery powered and may wirelessly transmit measured data over a wireless network within the designated area, thereby allowing the user to move freely through the designated area while being monitored. Although the measured data may be transmitted over a wireless network, the wireless network may be limited to power usage, data transmission range, throughput, and number of devices within the network.

### SUMMARY

The described features generally relate to methods, systems, devices, or apparatuses that support an athlete vital sign monitoring system. A gateway device may receive physiological measurement data from a sensor worn by an athlete during athletic activity. The sensor may be configured to transmit physiological data according to a Bluetooth 5 protocol. In some cases, the gateway device may identify a user associated with the physiological measurement based on an identity of the sensor. In that case, if the sensor is associated with the user, then the user may be identified. The gateway device may also store the received physiological measurement data.

A method for athlete monitoring is described. The method may include receiving, at a gateway device, physiological measurement data from a sensor configured to transmit wireless signals according to a Bluetooth 5 protocol, identifying a user associated with the received physiological measurement data based at least in part on an identity of the sensor, and storing at least the received physiological measurement data.

Some examples of the method described herein may further include receiving the physiological measurement data via one or more of a plurality of repeaters that are configured to transmit wireless signals according to the Bluetooth 5 protocol. In some cases, the plurality of repeaters may be arranged around a perimeter of an area designated for athletic activity. Some examples of the method described herein may further include receiving an advertising packet from the sensor, wherein at least a portion of the physiological measurement data is received within the advertising packet. Some examples of the method described herein may further include transmitting, to the sensor, a signal according to the Bluetooth 5 protocol. In some cases, the gateway device may be configured to receive wireless signals according to the Bluetooth 5 protocol.

In some cases, the sensor and the gateway device may comprise transceivers that are configured to operate according to the Bluetooth 5 protocol. In some cases, the sensor may be worn by the user during athletic activity. Some examples of the method described herein may further include receiving location data from the sensor, a different sensor worn by the user, or both. Some examples of the method described herein may further include receiving the physiological measurement data from the sensor on a first channel and receiving physiological measurement data from a second sensor on a second channel different from the first channel.

Some examples of the method described herein may further include operations, features, means, or instructions for receiving, at a gateway device, physiological measurement data from a sensor configured to transmit wireless signals according to a Bluetooth 5 protocol, identifying a user associated with the received physiological measurement data based at least in part on an identity of the sensor, and storing at least the received physiological measurement data.

### BRIEF DESCRIPTION OF THE DRAWINGS

FIG. 1 illustrates an example of a system for athlete monitoring that supports an athlete vital sign monitoring system in accordance with aspects of the present disclosure.

FIG. 2 illustrates an example of an athlete monitoring system that supports an athlete vital sign monitoring system in accordance with aspects of the present disclosure.

FIG. 3 illustrates an example of a process flow that supports an athlete vital sign monitoring system in accordance with aspects of the present disclosure.

FIGS. 4 and 5 show block diagrams of devices that support an athlete vital sign monitoring system in accordance with aspects of the present disclosure.

FIG. 6 shows a block diagram of an athlete monitoring manager that supports athlete vital sign monitoring system in accordance with aspects of the present disclosure.

FIG. 7 shows a diagram of a system including a device that supports an athlete vital sign monitoring system in accordance with aspects of the present disclosure.

FIGS. 8 through 10 show flowcharts illustrating methods that support an athlete vital sign monitoring system in accordance with aspects of the present disclosure.

### DETAILED DESCRIPTION

A sensor may monitor the physiological parameters of a user and transmit the physiological parameters via a wireless network. For example, the sensor may be worn by the user during physical activity to collect data parameters such heart rate, breathing rate, temperature, acceleration, and movement. In some cases, the data parameters may be transmitted via the wireless network according to a Bluetooth 5 protocol. The Bluetooth 5 protocol may be an example of a low power, long range wireless data transmission protocol that sends and receives communications between sensors worn by athletes and the network. In some cases, the sensor may transmit data parameters using one-way communication with the network via the Bluetooth 5 protocol. In other examples, the sensor may utilize two-way communication between the sensor and the network using the Bluetooth 5 protocol.

The Bluetooth 5 protocol may increase the capability and bandwidth of data transmission related to athlete vital sign monitoring. For example, a gateway device may receive a physiological measurement associated with the athletic activity of the user. The sensor may transmit the physiological measurement via wireless signals according to the Bluetooth 5 protocol. After the gateway device receives the physiological measurement, the gateway device may identify the user associated with the physiological measurement based on an identity of the sensor. For example, if the sensor worn by the athlete measures the heart rate of the athlete, the gateway device may determine the identity of the user based on receiving the heart rate from the sensor associated with the athlete. The gateway device may also store the physiological measurement.

In some examples, the Bluetooth 5 protocol may implement a beacon mode where the devices (e.g., sensors) connected within the network may transmit an advertising packet. In Bluetooth 5 protocol, the size of the advertising packet may be sufficiently large such that additional data may be piggybacked on the advertising packet. For example, the advertising packet may include information associated with the physiological measurement. In some cases, the physiological measurement may be relayed through multiple receivers (e.g., repeaters), thereby increasing the signal quality, the coverage area, or both. Implementing the Bluetooth 5 protocol in transmitters (e.g., sensors) and receivers (e.g., repeaters and gateway devices) may allow for a decrease in power usage, increase in data transmission range, increase in throughput, and an increase in a number of devices capable to transmit physiological measurements within the network.

Aspects of the disclosure are initially described in the context of a wireless monitoring system. Aspects of the disclosure are further illustrated by and described with reference to apparatus diagrams, system diagrams, and flowcharts that relate to an athlete vital sign monitoring system.

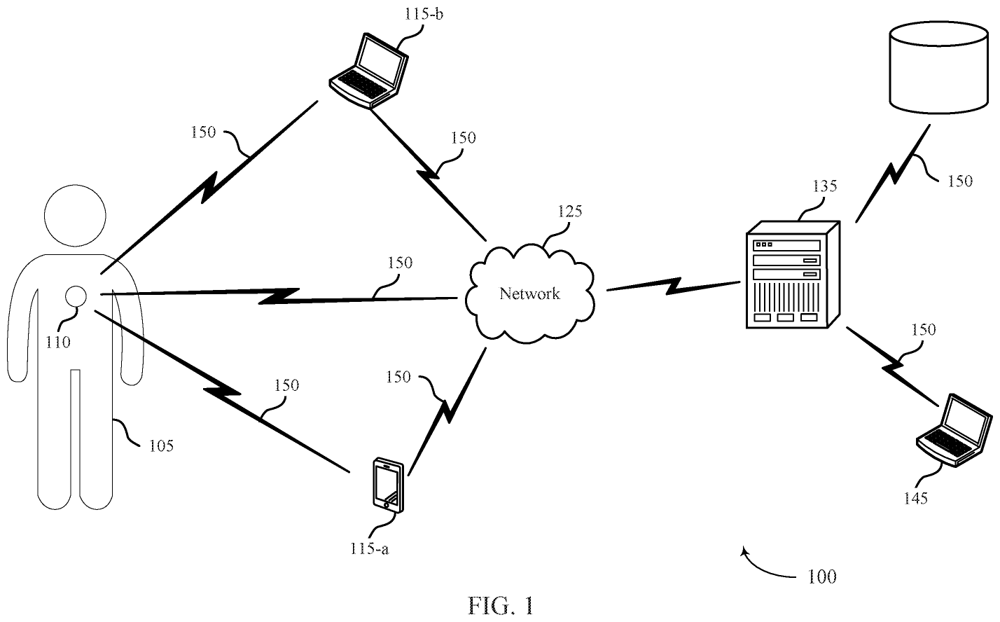

FIG. 1 illustrates an example of a wireless athlete monitoring system 100 in accordance with various embodiments of the present disclosure. The wireless athlete monitoring system 100 may include a user 105 (e.g., athlete) wearing, carrying, or otherwise coupled with a sensor 110. Although a sensor 110 is shown, multiple sensors 110 may be coupled to the user 105. The user 105 may be an athlete performing athletic activity. In some examples, the user 105 may be a patient in a hospital, nursing home, home care, a medical facility, another care facility, or a user performing everyday tasks. The sensor 110 may transmit signals via wireless communications links 150 to computing devices 115 or to a network 125.

The sensor 110 may include one or more sensors configured to collect a variety of physiological parameters as well as information related to the location and movement of the user 105. For example, the sensor 110 may include a pulse oximetry (SpO2) sensor, a capnography sensor, a heart rate sensor, a blood pressure sensor, an electrocardiogram (ECG) sensor, a respiratory rate sensor, a glucose level sensor, a depth of consciousness sensor, a body temperature sensor, an accelerometer, a global positioning sensor, a sensor which triangulates position from multiple local computing devices 115, or any other sensor configured to collect physiological, location, or motion data associated with the user 105. In some cases, the sensor 110 may be an example of a medical device configured to measure the physiological parameters of the user 105.

The sensor 110 may be coupled with the user 105 in a variety of ways depending on the data being collected. For example, the sensor 110 may be directly coupled with the user 105 (e.g., physically connected to the athlete's chest, worn around the athlete's wrist, attached to the athlete's finger, or positioned over the athlete's nose or mouth). The data collected by the sensor 110 may be wirelessly transmitted to either the computing devices 115 or to the remote computing device 145 (via the network 125 and central station 135). Data transmission may occur via, for example, frequencies appropriate for a personal area network (such as Bluetooth, Bluetooth Low Energy (BLE), Bluetooth 5, or IR communications) or local (e.g., wireless local area network (WLAN)) or wide area network (WAN) frequencies such as radio frequencies specified by IEEE standards (e.g., IEEE 802.15.4 standard, IEEE 802.11 standard (Wi-Fi), IEEE 802.16 standard (WiMAX), etc.).

Computing device 115-a may be a wireless device such as a tablet, cellular phone, personal digital assistant (PDA), a dedicated receiver, or other similar device or a spatially distributed network of devices configured to receive signals from the sensor 110. Computing device 115-b may be a wireless laptop computer. The computing devices 115 may be in communication with a central station 135 via network 125. In some cases, computing devices 115 may be an example of repeaters configured to transmit wireless signals. In some cases, repeaters may be implemented within network 125.

The sensor 110 may also communicate directly with the central station 135 via the network 125. The central station 135 may be a server located within in a remote location. For example, the central station 135 could be located in or near an athletic field where athletes are being monitored, or the central station 135 could be located remotely. The central station may also be an example of a gateway device located within proximity of computing devices 115 (e.g., repeaters) or the sensor 110 worn by the user or athlete. The central station 135 may be in further communication with one or more remote computing devices 145, thereby allowing a coach or other user provider to remotely monitor the user 105. The central station 135 may also be in communication with various remote databases 140 where the collected user data may be stored. In some cases, the remote databases 140 include electronic medical records (EMR) applications for storing and sharing user data.

In accordance with various embodiments, the central station 135 may receive physiological measurement data from the sensor 110. As described below in more detail, the sensor 110 may be configured to transmit wireless signals according to a Bluetooth 5 protocol. In some cases, the central station 135 may identify a user 105 (e.g., athlete) associated with the received physiological measurement data based on an identity of the sensor 110. The central station may also store at least the received physiological measurement data.

In some examples, the central station 135 may receive the physiological measurement data via a plurality of computing devices (e.g., repeaters). As described below in more detail, the repeaters may be configured to transmit wireless signals according to the Bluetooth 5 protocol. The physiological measurement data received from the sensor 110 may be included within an advertising packet. The sensor 110 may also transmit signals to the central station 135, where the signals may include location data associated with the user 105 or the sensor 110. The signals may be transmitted according to the Bluetooth 5 protocol.

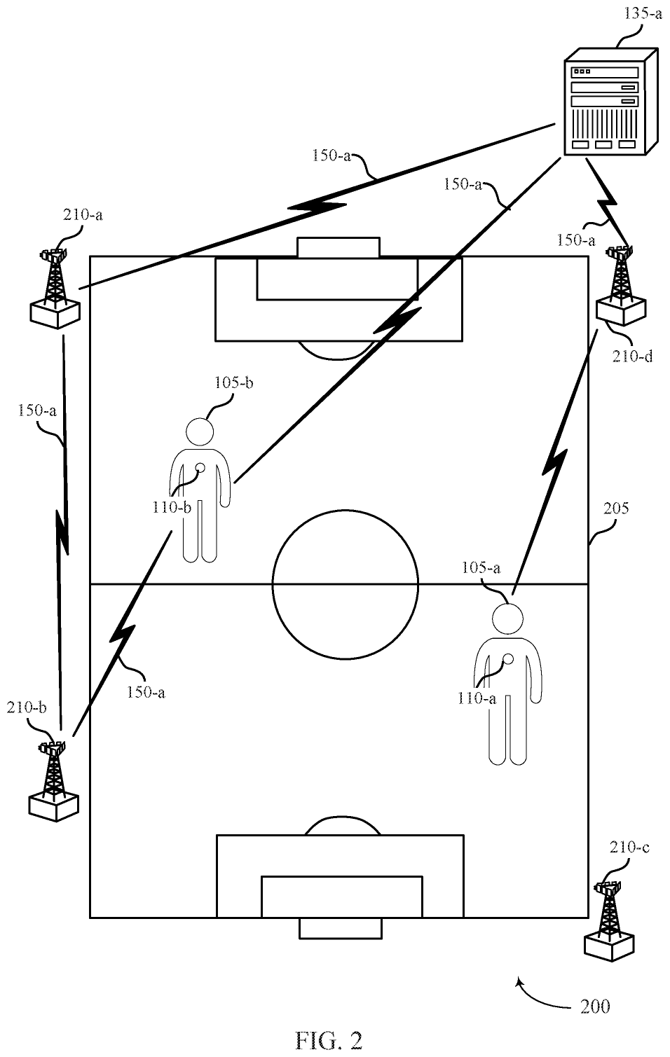

FIG. 2 illustrates an example of an athlete monitoring system 200 that supports an athlete vital sign monitoring system in accordance with aspects of the present disclosure. The athlete monitoring system 200 may be an example of aspects of the athlete monitoring system 100 and may include athletes 105-a and 105-b wearing, carrying, or otherwise coupled with sensors 110-a and 110-b, respectively. Athletes 105-a and 105-b and sensors 110-a and 110-b may be examples of a user 105 and sensor 110 described with reference to FIG. 1. Sensors 110-a and 110-b may each include one or more sensors configured to measure a variety of physiological parameters associated with athletes 105-a and 105-b, respectively. As described in more detail below, sensors 110-a and 110-b may transmit physiological measurement data to gateway device 135-a according to a Bluetooth 5 protocol. The sensors 110-a, 110-b may include hardware (e.g., processors, transceivers, radios, etc.) that are specifically configured for the upgraded capabilities of Bluetooth 5 as compared to previous Bluetooth protocols.

Sensors 110-a and 110-b may communicate bidirectionally via wireless communication links 150-a to repeaters 210-a, 210-b, 210-c, and 210-d or to gateway device 135-a. The gateway device 135-a may be an example of a server or a central station 135 described in reference to FIG. 1. Repeaters 210-a, 210-b, 210-c, and 210-d may be examples of a computing device 115 or network 125. Additionally or alternatively, repeaters 210-a, 210-b, 210-c, and 210-d may also be an example of a device that receives a wireless signal from sensors 110-a or 110-b and relays the signal to gateway device 135-a via wireless communication links 150-a. In some cases, sensors 110-a and 110-b, repeaters 210-a, 210-b, 210-c, and 210-d, and gateway device 135-a may each include one or more transceivers configured to operate according to the Bluetooth 5 protocol.

In some cases, athletes 105-a and 105-b may be located within perimeter 205. Perimeter 205 may be an example of, but is not limited to, an area designated for athletic activity such as a field or court. Sensors 110-a and 110-b may measure physiological parameters associated with athletes 105-a and 105-b before, during, or after athletic activity performed within perimeter 205. In some cases, sensors 110-a and 110-b may measure physiological parameters before, during, or after athletic activity performed outside perimeter 205. Physiological parameters may include, but are not limited to, vital signs associated with athletes 105-a and 105-b such as pulse rate, temperature, respiration rate, and blood pressure. In some cases, physiological parameters may include measurements such as blood glucose level, pulse oximetry, acceleration, movement and waveform data.

In some examples, repeaters 210-a, 210-b, 210-c, and 210-d may be arranged around perimeter 205. In some cases, repeaters 210-a. 210-b, 210-c, and 210-d may be arranged equal distance around perimeter 205. In other examples, repeaters 210-a, 210-b, 210-c, and 210-d may be at varying distances around perimeter 205.

In some examples, gateway device 135-a may receive physiological parameters associated with sensor 110-b via wireless communication links 150-a according to the Bluetooth 5 protocol. For example, gateway device 135-a may receive physiological parameters measured by sensor 110-b via wireless communication links 150-a directly connecting sensor 110-b and gateway device 135-a. In this case, the wireless signals may be transmitted according to the Bluetooth 5 protocol.

Gateway device 135-a may also receive physiological parameters associated with sensor 110-b via wireless communication links 150-a between sensor 110-b and repeaters 210-a and 210-b. For example, gateway device 135-a may receive physiological parameters measured by sensor 110-b via wireless communication links 150-a directly connecting sensor 110-b to repeater 210-b. In this case, repeater 210-b may be an example of a relay device which transmits the wireless signal from repeater 210-b to repeater 210-a. After repeater 210-a receives the wireless signal, repeater 210-a may transmit the wireless signal to gateway device 135-a. The wireless signals may be transmitted according to the Bluetooth 5 protocol.

In some cases, gateway device 135-a may receive physiological parameters associated with sensor 110-b via wireless communication links 150-a between sensor 110-a and repeater 210-d. For example, gateway device 135-a may receive physiological parameters measured by sensor 110-a via wireless communication links 150-a directly connecting sensor 110-b to repeater 210-d and wireless communication links 150-a directly connecting repeater 210-d to gateway device 135-a. In this case, the wireless signals may be transmitted according to the Bluetooth 5 protocol.

Sensors 110-a and 110-b may be configured to transmit and receive signals via wireless communication links 150-a according to Bluetooth 5 protocol. For example, sensors 110-a and 110-b may transmit location data to gateway device 135-a. The location data may be from sensor 110-a worn by athlete 105-a, sensor 110-b worn by athlete 105-b, or a different sensor worn by either athlete 105-a or 105-b. The location data may include the location of athletes 105-a and 105-b within perimeter 205. In some examples, the transmission of location data from sensors 110-a and 110-b to gateway device 135-a may be based on the triangulation of data.

In some cases, gateway device 135-a may receive an advertising packet from sensors 110-a and 110-b according to the Bluetooth 5 protocol. For example, a portion of the physiological parameter measured by sensors 110-a and 110-b may be included in the advertising packet. Advertising packets associated with the Bluetooth 5 protocol may be increased in size compared to advertising packets associated with other signal transmission protocols. In that case, physiological parameters may be transmitted to gateway device 135-a without establishing a connection and an unlimited number of sensors may transmit advertising packets to gateway device 135-a.

In some cases, sensors 110-a and 110-b may operate on different channels to mitigate interference during the transmission of physiological parameters to gateway device 135-a. For example, gateway device 135-a may receive physiological parameters from sensor 110-a on a first channel. Gateway device 135-a may also receive physiological parameters from a second sensor on athlete 105-a on a second channel different than the first. In some examples, gateway device 135-a may receive physiological parameters from sensor 110-b on a second channel different than the first channel, where the first channel is occupied by transmitting physiological parameters from sensor 110-a. When sensors 110-a and 110-b operate on different channels, the noise within perimeter 205 may also mitigate and the overlay at the receiver (e.g., gateway device 135-a) may be reduced.

After gateway device 135-a receives the physiological parameters, an identity of the athletes 105-a and 105-b may be determined. For example, sensor 110-a may be associated with athlete 105-a. In that case, gateway device 135-a may receive physiological parameters from sensor 110-a and identify athlete 105-a based on the association. Gateway device 135-a may also store the physiological parameters. In some cases, gateway device 135-a may store location data from sensors 110-a and 110-b.

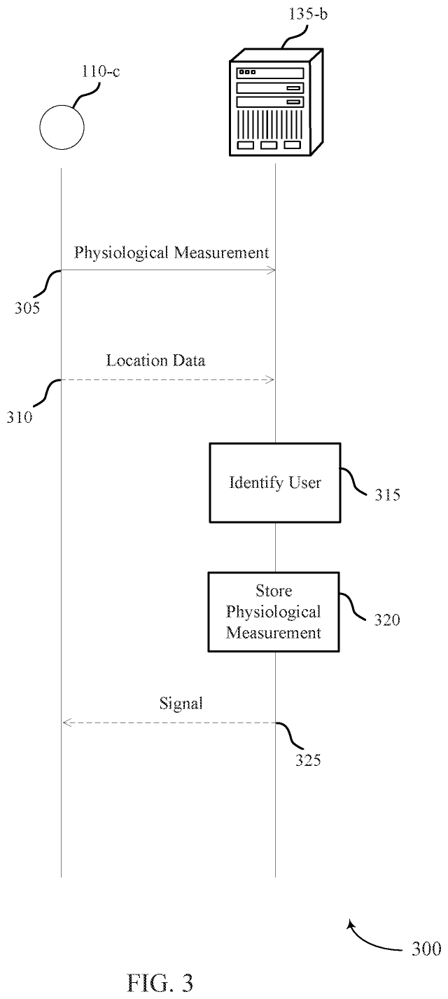

FIG. 3 illustrates an example of a process flow 300 that supports an athlete vital sign monitoring system in accordance with aspects of the present disclosure. Process flow 300 may include sensor 110-c and gateway device 135-b, which may be respective examples of a sensor 110 and central station 135 as described with reference to FIGS. 1 and 2. The gateway device 135-b may be an example of a central station or server, as described herein. Alternative examples of the following may be implemented, where some steps are performed in a different order or not at all. Some steps may additionally include additional features not mentioned above.

Sensor 110-c may transmit physiological measurement 305 (e.g., physiological measurement data). Gateway device 135-b may receive physiological measurement 305 from sensor 110-c, where sensor 110-c may be configured to transmit wireless signals according to Bluetooth 5 protocol. Gateway device 135-b may be configured to receive wireless signals according to Bluetooth 5 protocol.

In some examples, gateway device 135-b may receive physiological measurement data via one or more of a plurality of repeaters. For example, the repeaters may be configured to transmit wireless signals according to Bluetooth 5 protocol. The repeaters may also be arranged around a perimeter of an area designed for athletic activity.

In some cases, a portion of physiological measurement 305 may be received within an advertising packet from sensor 110-c. In some examples, physiological measurement 305 may be received from sensor 110-c on a first channel. In other examples, physiological measurement 305 may be received from a second sensor on a second channel different than the first channel.

Sensor 110-c may also transmit location data 310. In some cases, location data 310 may be received from sensor 110-c, a different sensor worn by the user, or both. Sensor 110-c may be worn by the user during athletic activity.

At block 315, gateway device 135-b may identify a user. For example, gateway device 135-b may identify a user associated with the received physiological measurement 305 based on an identity of sensor 110-c.

At block 320, gateway device 135-b may store the received physiological measurement 305. Sensor 110-c and gateway device 135-b may include transceivers configured to operate according to the Bluetooth 5 protocol. In some cases, gateway device 135-bs may transmit a signal according to Bluetooth 5 protocol to sensor 110-c.

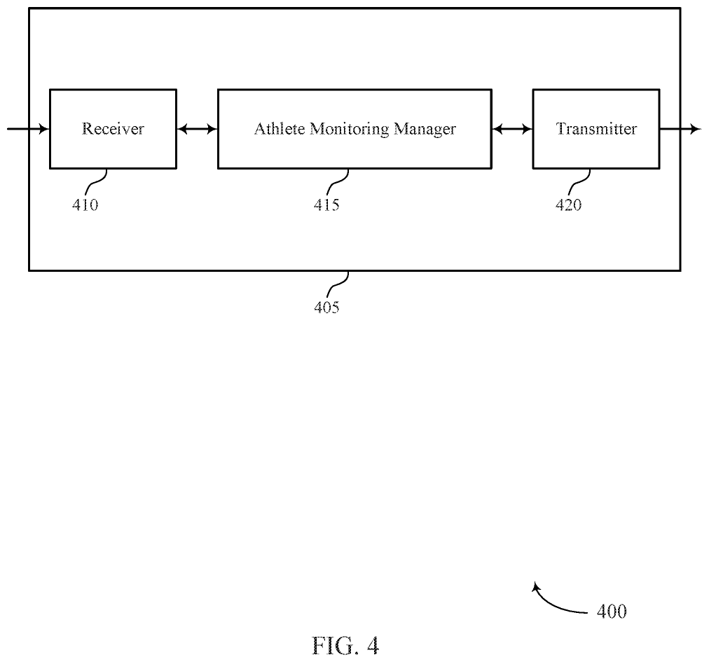

FIG. 4 shows a block diagram 400 of a device 405 that supports an athlete vital sign monitoring system in accordance with aspects of the present disclosure. The device 405 may be an example of aspects of a device as described herein. The device 405 may include a receiver 410, an athlete monitoring manager 415, and a transmitter 420. The device 405 may also include a processor. Each of these components may be in communication with one another (e.g., via one or more buses).

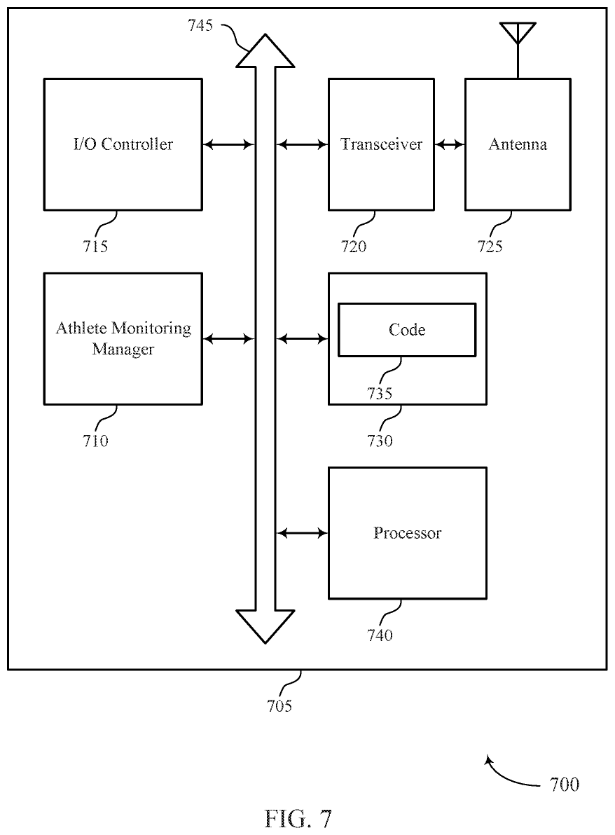

The receiver 410 may receive information such as packets, user data, or control information associated with various information channels (e.g., control channels, data channels, and information related to athlete vital sign monitoring system, etc.). Information may be passed on to other components of the device 405. The receiver 410 may be an example of aspects of the transceiver 720 described with reference to FIG. 7. The receiver 410 may utilize a single antenna or a set of antennas.

The athlete monitoring manager 415 may receive, at a gateway device, physiological measurement data from a sensor configured to transmit wireless signals according to a Bluetooth 5 protocol, identify a user associated with the received physiological measurement data based on an identity of the sensor, and store at least the received physiological measurement data. The athlete monitoring manager 415 may be an example of aspects of the athlete monitoring manager 710 described herein.

The athlete monitoring manager 415, or its sub-components, may be implemented in hardware, code (e.g., software or firmware) executed by a processor, or any combination thereof. If implemented in code executed by a processor, the functions of the athlete monitoring manager 415, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The athlete monitoring manager 415, or its sub-components, may be physically located at various positions, including being distributed such that portions of functions are implemented at different physical locations by one or more physical components. In some examples, the athlete monitoring manager 415, or its sub-components, may be a separate and distinct component in accordance with various aspects of the present disclosure. In some examples, the athlete monitoring manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 420 may transmit signals generated by other components of the device 405. In some examples, the transmitter 420 may be collocated with a receiver 410 in a transceiver module. For example, the transmitter 420 may be an example of aspects of the transceiver 720 described with reference to FIG. 7. The transmitter 420 may utilize a single antenna or a set of antennas. As described with reference to the previous figures, the components of the device 405 may be configured for the upgraded capabilities of the Bluetooth 5 protocol. For example, transmitter 420 may be configured to transmit wireless signals at a greater range and at higher data rates as compared to previous Bluetooth protocols. The components of device 405 may also be configured to operate on a lower power consumption as compared to previous Bluetooth protocols.

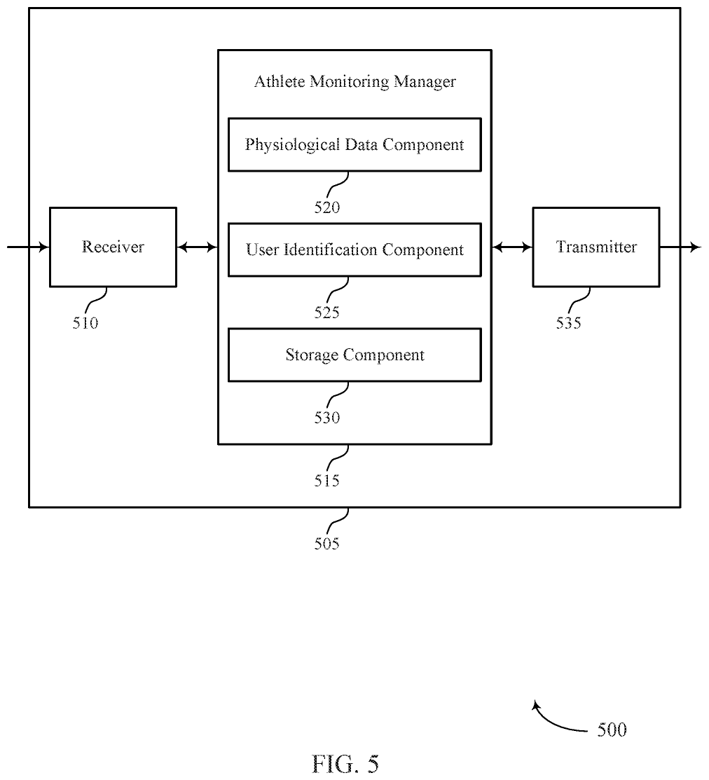

FIG. 5 shows a block diagram 500 of a device 505 that supports an athlete vital sign monitoring system in accordance with aspects of the present disclosure. The device 505 may be an example of aspects of a device 405 or a computing device 115 as described herein. The device 505 may include a receiver 510, an athlete monitoring manager 515, and a transmitter 535. The device 505 may also include a processor. Each of these components may be in communication with one another (e.g., via one or more buses).

The receiver 510 may receive information such as packets, user data, or control information associated with various information channels (e.g., control channels, data channels, and information related to athlete vital sign monitoring system, etc.). Information may be passed on to other components of the device 505. The receiver 510 may be an example of aspects of the transceiver 720 described with reference to FIG. 7. The receiver 510 may utilize a single antenna or a set of antennas.

The athlete monitoring manager 515 may be an example of aspects of the athlete monitoring manager 415 as described herein. The athlete monitoring manager 515 may include a physiological data component 520, a user identification component 525, and a storage component 530. The athlete monitoring manager 515 may be an example of aspects of the athlete monitoring manager 710 described herein.

The physiological data component 520 may receive, at a gateway device, physiological measurement data from a sensor configured to transmit wireless signals according to a Bluetooth 5 protocol.

The user identification component 525 may identify a user associated with the received physiological measurement data based on an identity of the sensor.

The storage component 530 may store at least the received physiological measurement data.

The transmitter 535 may transmit signals generated by other components of the device 505. In some examples, the transmitter 535 may be collocated with a receiver 510 in a transceiver module. For example, the transmitter 535 may be an example of aspects of the transceiver 720 described with reference to FIG. 7. The transmitter 535 may utilize a single antenna or a set of antennas.

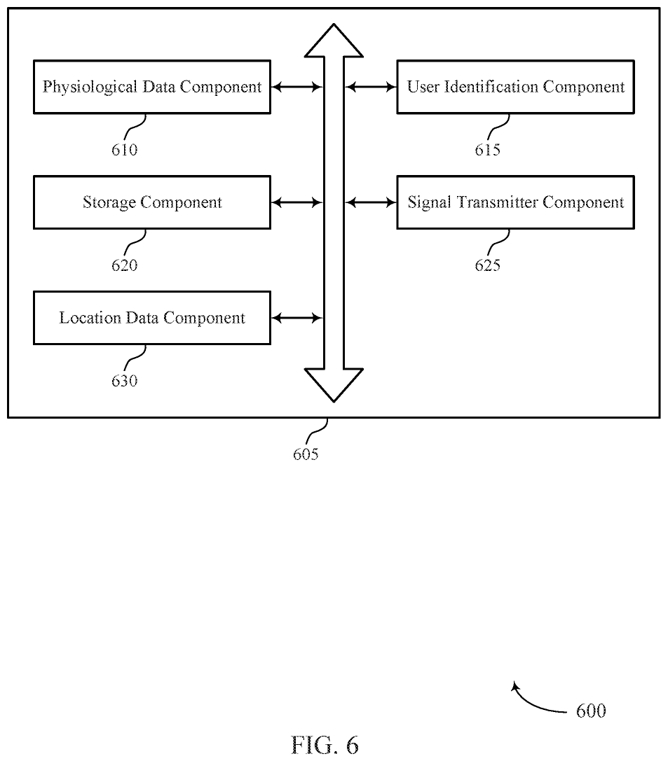

FIG. 6 shows a block diagram 600 of an athlete monitoring manager 605 that supports athlete vital sign monitoring system in accordance with aspects of the present disclosure. The athlete monitoring manager 605 may be an example of aspects of an athlete monitoring manager 415, an athlete monitoring manager 515, or an athlete monitoring manager 710 described herein. The athlete monitoring manager 605 may include a physiological data component 610, a user identification component 615, a storage component 620, a signal transmitter component 625, and a location data component 630. Each of these modules may communicate, directly or indirectly, with one another (e.g., via one or more buses).

The physiological data component 610 may receive, at a gateway device, physiological measurement data from a sensor configured to transmit wireless signals according to a Bluetooth 5 protocol. In some examples, the physiological data component 610 may receive an advertising packet from the sensor, where at least a portion of the physiological measurement data is received within the advertising packet. In some cases, the physiological data component 610 may receive the physiological measurement data from the sensor on a first channel. In some examples, the physiological data component 610 may receive physiological measurement data from a second sensor on a second channel different from the first channel.

The user identification component 615 may identify a user associated with the received physiological measurement data based on an identity of the sensor. In some cases, the sensor is worn by the user during athletic activity.

The storage component 620 may store at least the received physiological measurement data.

The signal transmitter component 625 may receive the physiological measurement data via one or more of a set of repeaters that are configured to transmit wireless signals according to the Bluetooth 5 protocol. In some examples, the signal transmitter component 625 may transmit, to the sensor, a signal according to the Bluetooth 5 protocol. In some cases, the set of repeaters are arranged around a perimeter of an area designated for athletic activity. In some cases, the gateway device is configured to receive wireless signals according to the Bluetooth 5 protocol. In some cases, the sensor and the gateway device include transceivers that are configured to operate according to the Bluetooth 5 protocol.

The location data component 630 may receive location data from the sensor, a different sensor worn by the user, or both.

FIG. 7 shows a diagram of a system 700 including a device 705 that supports an athlete vital sign monitoring system in accordance with aspects of the present disclosure. The device 705 may be an example of or include the components of device 405, device 505, or a device as described herein. The device 705 may include components for bi-directional voice and data communications including components for transmitting and receiving communications, including an athlete monitoring manager 710, an I/O controller 715, a transceiver 720, an antenna 725, memory 730, and a processor 740. These components may be in electronic communication via one or more buses (e.g., bus 745). As described with reference to FIG. 4, one or more of the components of FIG. 7 may be configured specifically for the Bluetooth 5 protocol.

The athlete monitoring manager 710 may receive, at a gateway device, physiological measurement data from a sensor configured to transmit wireless signals according to a Bluetooth 5 protocol, identify a user associated with the received physiological measurement data based on an identity of the sensor, and store at least the received physiological measurement data.

The I/O controller 715 may manage input and output signals for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The transceiver 720 may communicate bi-directionally, via one or more antennas, wired, or wireless links as described above. For example, the transceiver 720 may represent a wireless transceiver and may communicate bi-directionally with another wireless transceiver. The transceiver 720 may also include a modem to modulate the packets and provide the modulated packets to the antennas for transmission, and to demodulate packets received from the antennas.

In some cases, the wireless device may include a single antenna 725. However, in some cases the device may have more than one antenna 725, which may be capable of concurrently transmitting or receiving multiple wireless transmissions.

The memory 730 may include RAM and ROM. The memory 730 may store computer-readable, computer-executable code 735 including instructions that, when executed, cause the processor to perform various functions described herein. In some cases, the memory 730 may contain, among other things, a BIOS which may control basic hardware or software operation such as the interaction with peripheral components or devices.

The processor 740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In other cases, a memory controller may be integrated into the processor 740. The processor 740 may be configured to execute computer-readable instructions stored in a memory (e.g., the memory 730) to cause the device 705 to perform various functions (e.g., functions or tasks supporting athlete vital sign monitoring system).

The code 735 may include instructions to implement aspects of the present disclosure, including instructions to support athlete monitoring. The code 735 may be stored in a non-transitory computer-readable medium such as system memory or other type of memory. In some cases, the code 735 may not be directly executable by the processor 740 but may cause a computer (e.g., when compiled and executed) to perform functions described herein.

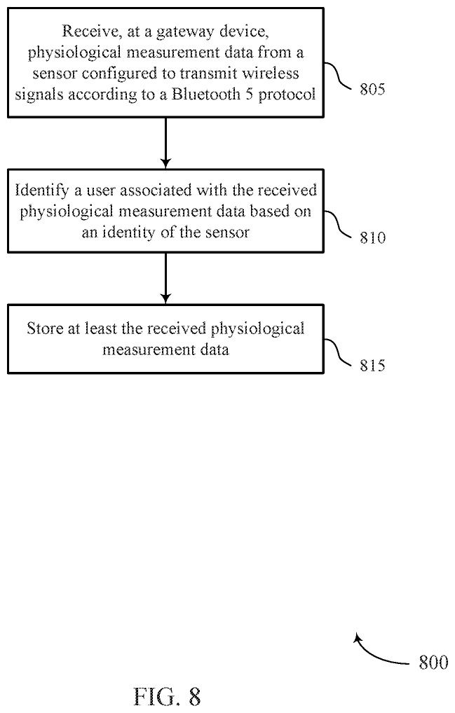

FIG. 8 shows a flowchart illustrating a method 800 that supports an athlete vital sign monitoring system in accordance with aspects of the present disclosure. The operations of method 800 may be implemented by a device or its components as described herein. For example, the operations of method 800 may be performed by an athlete monitoring manager as described with reference to FIGS. 4 through 7. In some examples, a device may execute a set of instructions to control the functional elements of the device to perform the functions described below. Additionally or alternatively, a device may perform aspects of the functions described below using special-purpose hardware.

At 805, the device may receive, at a gateway device, physiological measurement data from a sensor configured to transmit wireless signals according to a Bluetooth 5 protocol. The operations of 805 may be performed according to the methods described herein. In some examples, aspects of the operations of 805 may be performed by a physiological data component as described with reference to FIGS. 4 through 7.

At 810, the device may identify a user associated with the received physiological measurement data based on an identity of the sensor. The operations of 810 may be performed according to the methods described herein. In some examples, aspects of the operations of 810 may be performed by a user identification component as described with reference to FIGS. 4 through 7.

At 815, the device may store at least the received physiological measurement data. The operations of 815 may be performed according to the methods described herein. In some examples, aspects of the operations of 815 may be performed by a storage component as described with reference to FIGS. 4 through 7.

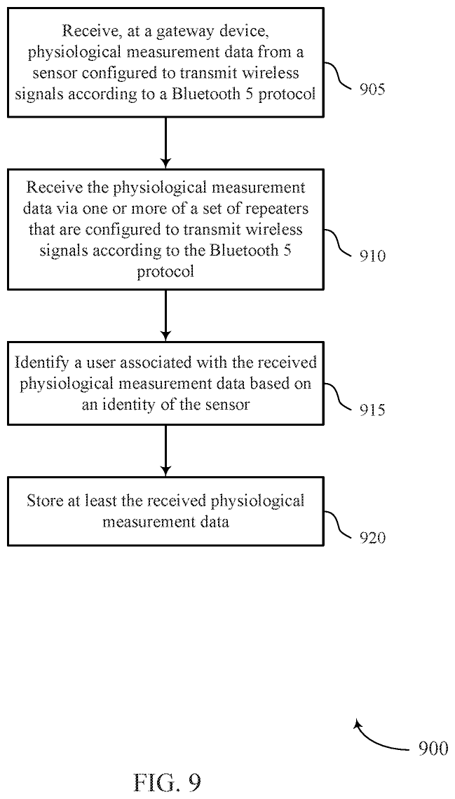

FIG. 9 shows a flowchart illustrating a method 900 that supports an athlete vital sign monitoring system in accordance with aspects of the present disclosure. The operations of method 900 may be implemented by a device or its components as described herein. For example, the operations of method 900 may be performed by an athlete monitoring manager as described with reference to FIGS. 4 through 7. In some examples, a device may execute a set of instructions to control the functional elements of the device to perform the functions described below. Additionally or alternatively, a device may perform aspects of the functions described below using special-purpose hardware.

At 905, the device may receive, at a gateway device, physiological measurement data from a sensor configured to transmit wireless signals according to a Bluetooth 5 protocol. The operations of 905 may be performed according to the methods described herein. In some examples, aspects of the operations of 905 may be performed by a physiological data component as described with reference to FIGS. 4 through 7.

At 910, the device may receive the physiological measurement data via one or more of a set of repeaters that are configured to transmit wireless signals according to the Bluetooth 5 protocol. The operations of 910 may be performed according to the methods described herein. In some examples, aspects of the operations of 910 may be performed by a signal transmitter component as described with reference to FIGS. 4 through 7.

At 915, the device may identify a user associated with the received physiological measurement data based on an identity of the sensor. The operations of 915 may be performed according to the methods described herein. In some examples, aspects of the operations of 915 may be performed by a user identification component as described with reference to FIGS. 4 through 7.

At 920, the device may store at least the received physiological measurement data. The operations of 920 may be performed according to the methods described herein. In some examples, aspects of the operations of 920 may be performed by a storage component as described with reference to FIGS. 4 through 7.

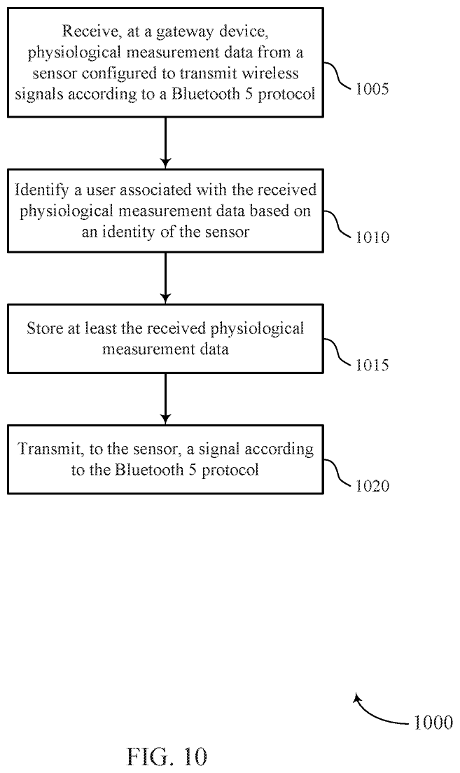

FIG. 10 shows a flowchart illustrating a method 1000 that supports an athlete vital sign monitoring system in accordance with aspects of the present disclosure. The operations of method 1000 may be implemented by a device or its components as described herein. For example, the operations of method 1000 may be performed by an athlete monitoring manager as described with reference to FIGS. 4 through 7. In some examples, a device may execute a set of instructions to control the functional elements of the device to perform the functions described below. Additionally or alternatively, a device may perform aspects of the functions described below using special-purpose hardware.

At 1005, the device may receive, at a gateway device, physiological measurement data from a sensor configured to transmit wireless signals according to a Bluetooth 5 protocol. The operations of 1005 may be performed according to the methods described herein. In some examples, aspects of the operations of 1005 may be performed by a physiological data component as described with reference to FIGS. 4 through 7.

At 1010, the device may identify a user associated with the received physiological measurement data based on an identity of the sensor. The operations of 1010 may be performed according to the methods described herein. In some examples, aspects of the operations of 1010 may be performed by a user identification component as described with reference to FIGS. 4 through 7.

At 1015, the device may store at least the received physiological measurement data. The operations of 1015 may be performed according to the methods described herein. In some examples, aspects of the operations of 1015 may be performed by a storage component as described with reference to FIGS. 4 through 7.

At 1020, the device may transmit, to the sensor, a signal according to the Bluetooth 5 protocol. The operations of 1020 may be performed according to the methods described herein. In some examples, aspects of the operations of 1020 may be performed by a signal transmitter component as described with reference to FIGS. 4 through 7.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). A processor may in some cases be in electronic communication with a memory, where the memory stores instructions that are executable by the processor. Thus, the functions described herein may be performed by one or more other processing units (or cores), on at least one integrated circuit (IC). In various examples, different types of ICs may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, electrically erasable programmable read only memory (EEPROM), compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for athlete monitoring, comprising:
receiving, at a gateway device, physiological measurement data from a sensor configured to transmit wireless signals according to a Bluetooth 5 protocol;
identifying a user associated with the received physiological measurement data based at least in part on an identity of the sensor; and
storing at least the received physiological measurement data.

2. The method of claim 1, further comprising:
receiving the physiological measurement data via one or more of a plurality of repeaters that are configured to transmit wireless signals according to the Bluetooth 5 protocol.

3. The method of claim 2, wherein the plurality of repeaters are arranged around a perimeter of an area designated for athletic activity.

4. The method of claim 1, further comprising:
receiving an advertising packet from the sensor, wherein at least a portion of the physiological measurement data is received within the advertising packet.

5. The method of claim 1, further comprising:
transmitting, to the sensor, a signal according to the Bluetooth 5 protocol.

6. The method of claim 1, wherein the gateway device is configured to receive wireless signals according to the Bluetooth 5 protocol.

7. The method of claim 1, wherein the sensor and the gateway device comprise transceivers that are configured to operate according to the Bluetooth 5 protocol.

8. The method of claim 1, wherein the sensor is worn by the user during athletic activity.

9. The method of claim 1, further comprising:
receiving location data from the sensor, a different sensor worn by the user, or both.

10. The method of claim 1, further comprising:
receiving the physiological measurement data from the sensor on a first channel; and
receiving physiological measurement data from a second sensor on a second channel different from the first channel.

11. An apparatus for athlete monitoring, comprising:
a processor;
memory in electronic communication with the processor;
instructions stored in the memory and executable by the processor to cause the apparatus to;
receive, at a gateway device, physiological measurement data from a sensor configured to transmit wireless signals according to a Bluetooth 5 protocol;
identify a user associated with the received physiological measurement data based at least in part on an identity of the sensor; and
store at least the received physiological measurement data.

12. The apparatus of claim 11, wherein the instructions are further executable by the processor to cause the apparatus to:
receive the physiological measurement data via one or more of a plurality of repeaters that are configured to transmit wireless signals according to the Bluetooth 5 protocol.

13. The apparatus of claim 11, wherein the instructions are further executable by the processor to cause the apparatus to:
receive an advertising packet from the sensor, wherein at least a portion of the physiological measurement data is received within the advertising packet.

14. The apparatus of claim 11, wherein the instructions are further executable by the processor to cause the apparatus to:
transmit, to the sensor, a signal according to the Bluetooth 5 protocol.

15. The apparatus of claim 11, wherein the instructions are further executable by the processor to cause the apparatus to:
receive location data from the sensor, a different sensor worn by the user, or both.

16. A non-transitory computer-readable medium storing code for athlete monitoring, the code comprising instruction executable by a processor to:
receive, at a gateway device, physiological measurement data from a sensor configured to transmit wireless signals according to a Bluetooth 5 protocol;
identify a user associated with the received physiological measurement data based at least in part on an identity of the sensor; and
store at least the received physiological measurement data.

17. The non-transitory computer-readable medium of claim 16, wherein the instructions are further executable to:
receive the physiological measurement data via one or more of a plurality of repeaters that are configured to transmit wireless signals according to the Bluetooth 5 protocol.

18. The non-transitory computer-readable medium of claim 16, wherein the instructions are further executable to:
receive an advertising packet from the sensor, wherein at least a portion of the physiological measurement data is received within the advertising packet.

19. The non-transitory computer-readable medium of claim 16, wherein the instructions are further executable to:
transmit, to the sensor, a signal according to the Bluetooth 5 protocol.

20. The non-transitory computer-readable medium of claim 16, wherein the instructions are further executable to:
receive location data from the sensor, a different sensor worn by the user, or both.
